(19) United States
(12) Patent Application Publication
(10) Pub. No.: US 2006/0043102 A1
(43) Pub. Date: Mar. 2, 2006

(54) Method and apparatus for applying solvent

(76) Inventors: Marc L. Keller, Salem, IL (US); Soundararajan Angannan, O'Fallon, IL (US); Charles E. Byars, Texico, IL (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 10/930,484

(22) Filed: Aug. 31, 2004

(51) Int. Cl. G01F 11/00; B67B 7/00

(52) U.S. Cl. 222/1

(57) ABSTRACT

A solvent applicator for applying a solvent to a web, wherein the solvent is supplied through a first solvent line from a solvent tank via a pressure increase in the solvent tank from a pressure source, includes a controller, and a first valve in flow communication with the pressure source, wherein the first valve is configured to control an amount of pressure output based on a signal received from the controller. The solvent applicator also includes a second valve in flow communication with the first valve and in flow communication with the first solvent line. The second valve is configured to control an amount of solvent output based on the amount of the pressure output from the first valve. The solvent applicator also includes a dispensing nozzle coupled in flow communication with the second valve, wherein the dispensing nozzle is configured to receive the solvent output from the second valve, and wherein the dispensing nozzle is positioned a distance above the web.

### BACKGROUND OF THE INVENTION

This invention relates generally to solvent applicators, and more particularly, to methods and apparatus for applying solvent to a web of material.

Applicators are generally known for dispensing a viscous fluid, such as an adhesive, a lubricant, a sealant, or the like. Some known applicators employ a dispensing nozzle to apply the viscous fluid to a web of material that is continuously passed beneath the nozzle. Depending on the application, the fluid being dispensed may be projected from the nozzle, either in a stream over the width of the web of material, or as a bead dispensed as a continuous strip along the web. In either application, the amount of fluid dispensed per unit of linear distance along the web will vary according to the relative velocity of the web. Accordingly, the flow rate of the fluid must be continuously adjusted to accommodate for the change in velocity of the web.

Other known applicators channel a supply of viscous fluid from a storage tank to the dispensing nozzle via a solvent line. These applicators generally include a pressure regulator for regulating the pressure in the tank to control the amount of fluid channeled from the tank to the dispensing nozzle. However, due to the volume of compressed solvent channeled through the solvent line and the corresponding amount of stored energy in that volume of solvent, these known applicators are typically slow to respond to changes in the flow rate preferred by a controller because of the lag in the system response. As such, a non-uniform amount of fluid may be applied to the web material providing reduced quality and/or scrap material. Specifically, when the web is accelerated and the controller increases the flow rate of the solvent, the volume of solvent in the solvent line must be compressed before a response is seen at the dispensing nozzle. Similarly, when the web is decelerating, the controller decreases the flow rate and the volume of material must decompress by dispensing the dispensing nozzle before achieving the desired reduction in system pressure. In either situation, known applicators have a lag in response time leading to reduced quality products.

Other known applicators employ a felt or brush applicator to directly apply the viscous fluid to the web of material. These known systems are generally supplied with an amount of solvent through a positive displacement metering valve or other pumping mechanism which creates pulsations of solvent for saturating the applicator. However, these known applicators may have a variance in the amount of solvent applied to the web leading to an inconsistent application of solvent to the web. This causes reduced quality and/or scrap portions in the web material.

### BRIEF DESCRIPTION OF THE INVENTION

In one aspect, a solvent applicator is provided for applying a solvent to a web, wherein the solvent is supplied through a first solvent line from a solvent tank via a pressure increase in the solvent tank from a pressure source. The solvent applicator includes a controller, a first valve in flow communication with the pressure source, wherein the first valve is configured to control an amount of pressure output based on a signal received from the controller, and a second valve in flow communication with the first valve and in flow communication with the first solvent line. The second valve is configured to control an amount of solvent output based on the amount of the pressure output from the first valve. The solvent applicator also includes a dispensing nozzle coupled in flow communication with the second valve, wherein the dispensing nozzle is configured to receive the solvent output from the second valve, and wherein the dispensing nozzle is positioned a distance above the web.

In another aspect, a solvent applicator system is provided for applying a solvent to a web. The system includes a controller, and a pressure supply sub-system including a pressure supply, at least one supply line, a control valve in flow communication with the pressure supply by a first of the supply lines, and a mode selector valve in flow communication with the pressure source by a second of the supply lines. The control valve is configured to control an amount of pressure output from the control valve based on a signal received from the controller. The solvent applicator system also includes a solvent supply sub-system including a solvent tank, at least one solvent line, a proportional valve in flow communication with the solvent tank via a first of the solvent lines, and a dispensing nozzle in flow communication with the proportional valve. The dispensing valve is in flow communication with the control valve, and the proportional valve is configured to control an amount of solvent output to the dispensing nozzle based on the amount of the pressure output from the control valve. The dispensing nozzle is configured to apply the solvent to the web.

In yet another aspect, a solvent applicator system is provided for applying a solvent to a web, wherein the solvent is supplied through a first solvent line from a solvent tank via a pressure increase in the solvent tank from a pressure source. The system includes a sensor configured to detect a line speed of the web, and a controller configured to receive the signal from the sensor. The system also includes a first valve in flow communication with the pressure source, wherein the first valve is configured to control an amount of pressure output based on a signal received from the controller relating to the line speed of the web, and a second valve in flow communication with the first valve and in flow communication with the first solvent line. The second valve is configured to control an amount of solvent output based on the amount of the pressure output from the first valve relating to the line speed of the web. The system also includes a dispensing nozzle coupled in flow communication with the second valve. The dispensing nozzle is configured to receive the solvent output from the second valve relating to the line speed of the web.

In a further aspect, a method of operating a solvent applicator system is provided, wherein the solvent applicator system includes a controller, a pressures supply for supplying a pressurized fluid, at least one supply line for channeling the pressurized fluid, a plurality of valves, a solvent tank, at least one solvent line for channeling the solvent, and a dispensing nozzle for applying the solvent to a web of material. The method includes supplying pressure to the tank through a first valve, supplying pressure to a dispensing nozzle through a second valve and a third valve, and supplying solvent from the tank to the nozzle through the third valve, wherein the pressure supplied to the third valve is proportional to the speed of the web.

### BRIEF DESCRIPTION OF THE DRAWINGS

FIG. 1 is a top view of a web of material used to fabricate a shrink sleeve in accordance with the present invention.

FIG. 2 is an end view of the shrink sleeve in a formed state and fabricated from the web of material shown in FIG. 1.

FIG. 3 is a schematic illustration of an exemplary solvent applicator system for applying solvent to the web of material as shown in FIG. 1.

FIG. 4 is a schematic illustration of the solvent applicator system shown in FIG. 3 in a run mode of operation.

FIG. 5 is a schematic illustration of the solvent applicator system shown in FIG. 3 in a purge mode of operation.

### DETAILED DESCRIPTION OF THE INVENTION

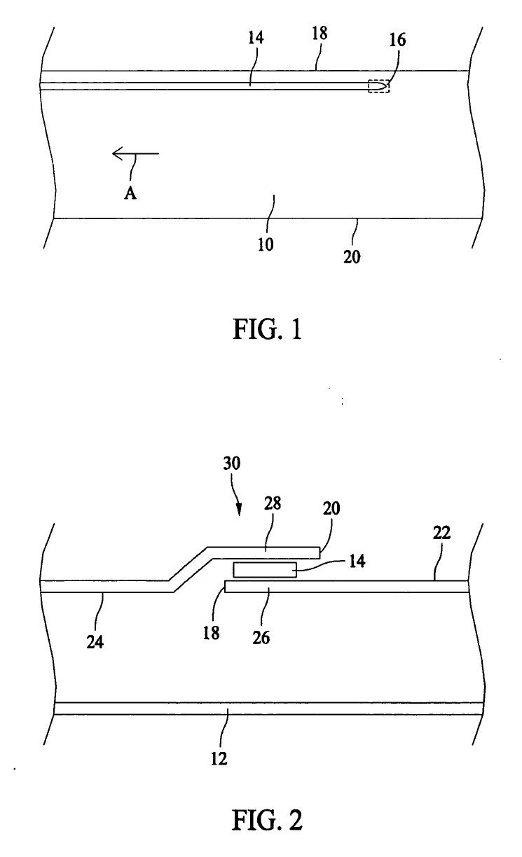

FIG. 1 illustrates a top view of a web 10 of material. In the exemplary embodiment, web 10 is fabricated from a plastic material, such as, but not limited to, oriented polystyrene (OPS). In an alternative embodiment, the plastic material may be, for example, a polyvinyl chloride (PVC) material, a polyester (PET) material, a glycol-modified polyester (GPET) material, or the like. In the exemplary embodiment, web 10 travels in the direction of arrow A as a strip of solvent 14 is applied to a surface of web 10. In the exemplary embodiment, solvent 14, also referred to hereinafter as adhesive, is applied generally in an area of application 16. Area of application 16 is positioned between a first end 18 and a second end 20 of web 10. In one embodiment, area of application 16 is positioned proximate first end 18.

FIG. 2 illustrates an end view of a shrink sleeve 12 in a formed state and fabricated from web 10 (shown in FIG. 1). Specifically, adhesive 14 is applied to a portion of shrink sleeve 12 prior to forming a tubular sleeve. In the exemplary embodiment, adhesive 14 is applied to a first surface 22 of shrink sleeve 12 proximate first end 18. Second end 20 is wrapped around first end 18 and a second surface 24 of shrink sleeve 12 is coupled to adhesive 14 to form the tubular sleeve. As such, adhesive 14 is positioned between an under flap 26, extending from first end 18, and an over flap 28, extending from second end 20. Over flap 28, solvent 14, and under flap 26 define a seam 30 in shrink sleeve 12.

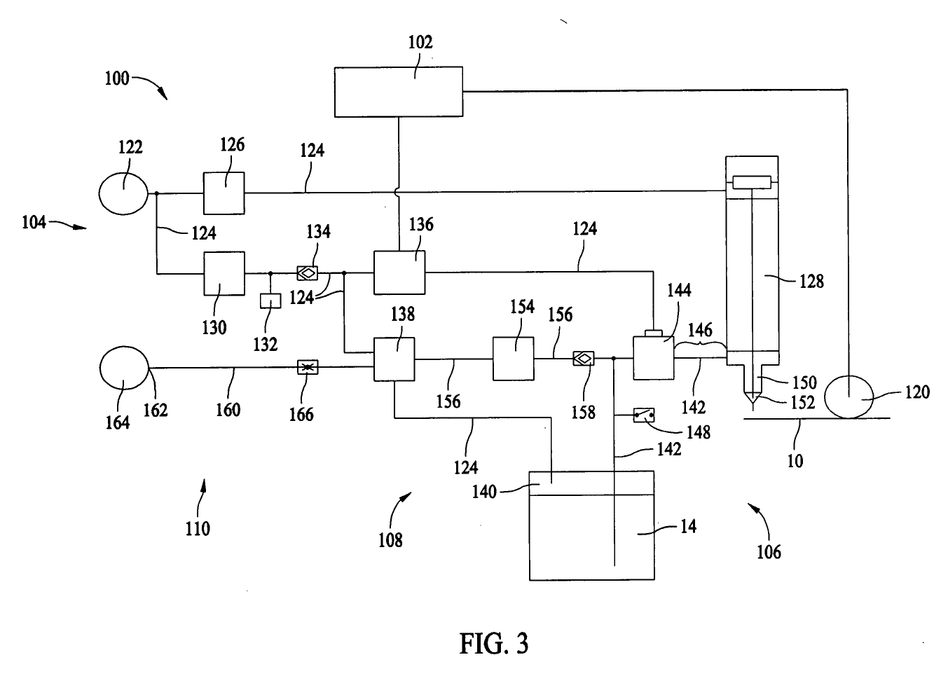

FIG. 3 is a schematic illustration of solvent applicator system 100 for applying solvent 14 to web 10 as shown in FIG. 1. Solvent applicator system 100 is configured for applying the strip of solvent 14 to the web 10. However, it is to be understood that the invention can be utilized in and for a variety of applications, including, but not limited to, the fabrication of shrink sleeves, such as shrink sleeve 12. It is appreciated that the benefits and advantages of the invention may occur in a variety of applicator systems that may be utilized in fabricating a variety of products fabricated from a web-like material. While the invention is described and illustrated in the context of a solvent applicator system 100 for applying adhesive 14 for shrink sleeves 12, the invention is not limited thereto. In one embodiment, solvent applicator system 100 is configured to apply less than approximately 10 micro-liters of solvent 14 per linear foot of web 10. In another embodiment, solvent applicator system 100 is configured to apply between approximately four and six micro-liters of solvent 14 per linear foot of web 10.

Solvent applicator system 100 includes a controller 102, a pressure supply sub-system 104, and a solvent supply sub-system 106. In one embodiment, solvent applicator system 100 also includes a purge sub-system 108 and an exhaust sub-system 110. In the exemplary embodiment, solvent applicator system 100 includes a sensor 120, such as, but not limited to, a line speed encoder or a rotary encoder for determining the speed of web 10. In another embodiment, sensor 120 is a generator coupled to a roller (not shown) for determining the speed of the roller, and thus, the speed of web 10. In the exemplary embodiment, sensor 120 transmits a signal in the form of pulses to controller 102 corresponding to the relative velocity of web 10 with respect to system 100. The pulse signal is processed by controller 102 and multiplied using a pre-defined scalar to obtain a scaled analog output value that is used by controller 102 to control pressure supply sub-system 104 and/or solvent supply sub-system 106.

Pressure supply sub-system 104 includes a supply source 122 for supplying a pressurized fluid, such as, for example, air, and a plurality of supply lines 124, such as, for example, air hoses. In the exemplary embodiment, supply source 122 supplies pressurized fluid to system 100 at approximately eighty pounds per square inch (“psi”). However, in an alternative embodiment, supply source 122 supplies pressurized fluid at more or less than eighty psi. Supply lines 124 couple each of the components of pressure supply sub-system 104 in flow communication with other components of sub-system 104.

In the exemplary embodiment, pressure supply sub-system 104 includes a dispensing valve 126. In one embodiment, dispensing valve 126 is an on/off solenoid valve, however, dispensing valve 126 is not limited thereto. Dispensing valve 126 is operable in an “ON” mode of operation, where pressurized fluid from supply source 122 is channeled through dispensing valve 126 to a dispensing nozzle 128. Dispensing valve 126 is also operable in an “OFF” mode of operation, where pressurized fluid from supply source 122 is restricted from flowing through dispensing valve 126 to dispensing nozzle 128. As such, dispensing valve 126 controls the operation of dispensing nozzle 128.

Pressure supply sub-system 104 also includes a pressure regulator 130 coupled in flow communication with supply source 122 via a supply line 124. Pressure regulator 130 regulates the pressure in pressure supply sub-system 104 to a predetermine pressure. In one embodiment, pressure regulator 130 limits the pressure in pressure supply sub-system 104 to a pressure that is approximately thirty psi. However, in alternative embodiments, pressure regulator 130 limits the pressure in pressure supply sub-system 104 to a pressure that is greater than or less than thirty psi. In one embodiment, pressure supply sub-system 104 also includes a safety relief valve 132 coupled downstream of, and in flow communication with, pressure regulator 130. Safety relief valve 132 limits the overall pressure in pressure supply sub-system 104 to a predetermined maximum pressure so that pressure supply sub-system 104 does not become over-pressurized. As such, safety relief valve 132 protects pressure supply sub-system 104 components downstream of pressure regulator 130 and reduces the occurrence of supply line 124 burst due to over-pressurizing. In the exemplary embodiment, pressure supply sub-system 104 also includes a check valve 134 to prevent back flow of pressurized fluid into pressure regulator 130. As such, pressure supply sub-system 104 limits flow at pressure regulator 130 to one way flow.

Pressure supply sub-system 104 includes a controller valve 136 for supplying and/or controlling an amount of pressurized fluid supplied to solvent supply sub-system 106, as will be described in detail below. Specifically, the amount of pressure output of controller valve 136 is variable to control the dispensing rate of solvent supply sub-system 106. In the exemplary embodiment, controller valve 136 is an electro-pneumatic (“E/P”) valve, however, controller valve 136 is not limited thereto. In the exemplary embodiment, controller valve 136 is coupled to controller 102 and receives signals from controller 102, such as, but not limited to, electrical signals relating to the speed of web 10. Controller valve 136 changes the received electrical signals, specifically the scaled analog output value from controller 102, into a predetermined output pressure of fluid flow through controller valve 136. In one embodiment, controller valve 136 is variably operable to output a pressure of between approximately zero and ten psi. However, in alternative embodiments, controller valve 136 has an output of greater than ten psi.

Pressure supply sub-system 104 includes a mode selector valve 138 that is operable in an “AUTO” or “RUN” mode of operation and a “PURGE” mode of operation. In the RUN mode, mode selector valve 138 channels the pressurized fluid supplied from pressure regulator 130 to a solvent tank 140. As such, supply source 122 is used to pressurize solvent tank 140 to dispense solvent 14 through solvent supply sub-system 106, as will be described in detail below. In the exemplary embodiment, pressure supply sub-system 104 pressurizes solvent tank 140 to a pressure of approximately thirty psi. However, in alternative embodiments, pressure supply sub-system 104 pressurizes solvent tank 140 to more or less than thirty psi, depending on the application. In the PURGE mode, mode selector valve 138 channels the pressurized fluid from pressure regulator 130 to the purge sub-system 108. PURGE mode of operation is utilized to purge solvent 14 in solvent supply sub-system 106 back into solvent tank 140. As such, an amount of solvent 14 waste is minimized.

Solvent supply sub-system 106 includes solvent tank 140 for storing an amount of solvent 14, and a plurality of solvent lines 142 such as, for example, fluid hoses. In the exemplary embodiment, solvent tank is approximately a one gallon storage tank, however is not limited thereto. Solvent lines 142 couple each of the components of solvent supply sub-system 106 in flow communication with other components of sub-system 106.

Solvent supply sub-system 106 also includes a proportional valve 144 and dispensing nozzle 128. While solvent supply sub-system 106 is described as including proportional valve 144, the valve is not limited to proportional valve 144. In the exemplary embodiment, proportional valve 144 is in flow communication with, and is supplied solvent 14 from, solvent tank 140 via one of solvent lines 142. Additionally, proportional valve 144 is in flow communication with, and supplies solvent 14 to dispensing nozzle 128. In one embodiment, proportional valve 144 supplies solvent 14 to dispensing nozzle 128 via one of solvent lines 142. Solvent line 142 has a length 146 selected to facilitate reducing a reaction time or system lag time of solvent supply sub-system 106 by reducing the amount of solvent 14 between proportional valve 144 and dispensing nozzle 128. As such, the amount of overall stored energy in solvent 14 is reduced because of the small volume of solvent 14 between proportional valve 144 and dispensing nozzle 128. Additionally, the overall responsiveness of solvent supply sub-system 106 is increased due to the minimal amount of stored energy that must be increased or decreased. In one embodiment, length 146 is less than ten inches. In another embodiment, length 146 is between approximately four and six inches. In yet another embodiment, length 146 is less than four inches. However, in a further embodiment, length 146 is selected to be greater than ten inches. In another embodiment, proportional valve 144 is directly coupled to dispensing nozzle 128 thereby reducing the volume of solvent 14 between proportional valve 144 and dispensing nozzle 128. Additionally, the diameter of solvent line 142 may be reduced to reduce the amount of solvent between proportional valve 144 and dispensing nozzle 128. In one embodiment, diameter of solvent line 142 is less than one inch. In another embodiment, diameter of solvent line 146 is between approximately ½ inch and 1/16 inch.

In operation, solvent 14 in solvent supply sub-system 106 is channeled through one of solvent lines 142 from solvent tank 140 to proportional valve 144 due to the pressure supplied by pressure supply sub-system 104 to solvent tank 140. In one embodiment, solvent supply sub-system 106 includes a pressure switch 148 coupled to solvent line 142 between solvent tank 140 and proportional valve 144. Pressure switch 148 detects the pressure of solvent 14 supplied to proportional valve 144, and, if the pressure of solvent 14 falls below a predetermined pressure, pressure switch 148 signals an alarm condition. In one embodiment, pressure switch 148 signals controller 102 of the alarm condition, and controller 102 halts operation of system 100.

In addition to the pressure supplied to solvent tank 140, pressure supply sub-system 104 also supplies pressure directly to the components in solvent supply sub-system 106. Specifically, controller valve 136 supplies pressurized fluid to solvent supply sub-system 106. In the exemplary embodiment, controller valve 136 supplies pressure to solvent supply sub-system 106 via a supply line 124 to proportional valve 144. In the exemplary embodiment, the amount of pressure supplied to proportional valve 144 is directly proportional to the signal from controller 102, and thus is directly proportional to the speed of web 10 as detected by sensor 120. Additionally, the amount of pressure supplied to proportional valve 144 from controller valve 136 controls the amount of solvent 14 output from proportional valve 144 to dispensing nozzle 128. As such, solvent 14 dispensed from dispensing nozzle 128 is directly proportional to the amount of pressure supplied to proportional valve 144, which is directly proportional to the speed of web 10. As such, solvent 14 dispensed corresponds to the velocity of the web 10, thereby providing a uniform strip of solvent 14 along the length of web 10, independent of the velocity that web 10 travels during application.

In the exemplary embodiment, dispensing nozzle 128 includes a nozzle valve 150 for controlling the operation of dispensing nozzle 128, and a dispensing tip 152 for dispensing solvent 14. Specifically, nozzle valve 150 is controlled by dispensing valve 126. In the exemplary embodiment, dispensing valve 126 is operable in an “ON” mode of operation, where pressurized fluid is supplied from dispensing valve 126 to dispensing nozzle 128, and an “OFF” mode of operation, where pressurized fluid from dispensing valve 126 is restricted from flowing to dispensing nozzle 128. In an alternative embodiment, the operation of dispensing nozzle 128 is controlled by proportional valve 144. Specifically, proportional valve 144 is operable in both the “ON” mode of operation, wherein pressure is supplied to proportional valve 144 by controller valve 136, and the “OFF” mode of operation, wherein zero pressure is supplied to proportional valve 144 by controller valve 136. As such, dispensing tip 152 may be operatively coupled directly to proportional valve 144 for dispensing solvent 14.

Solvent applicator system 100 also includes purge sub-system 108 and exhaust sub-system 110. In the exemplary embodiment, purge and exhaust sub-systems 108 and 110 are generally operated together to purge solvent supply sub-system 106. In the exemplary embodiment, purge sub-system 108 includes a purge regulator 154 for regulating the amount of pressure supplied to solvent supply sub-system 106 during the purge process. In one embodiment, purge regulator 154 supplies a pressure such as, for example, approximately ten psi. However, in alternative embodiments, purge regulator 154 supplies more or less than ten psi of pressure. In the exemplary embodiment, purge regulator 154 is coupled in flow communication with, and downstream of, mode selector valve 138. Additionally, purge regulator 154 is coupled in flow communication via a purge line 156 with solvent line 142 extending between solvent tank 140 and proportional valve 144. In one embodiment, a check valve 158 is coupled to purge line 156 to prevent solvent 14 from being channeled from solvent line 142 into purge line 156. Moreover, exhaust sub-system 110 includes an exhaust line 160 and an exhaust outlet 162. In one embodiment, exhaust sub-system 110 includes a ventilation system 164, such as a hood, for ventilating the exhaust fumes. In another embodiment, exhaust sub-system 110 includes a flow restrictor 166 coupled in flow communication with exhaust line 160. Flow restrictor 166 facilitates preventing sudden venting which may condense solvent 14 in exhaust line 160.

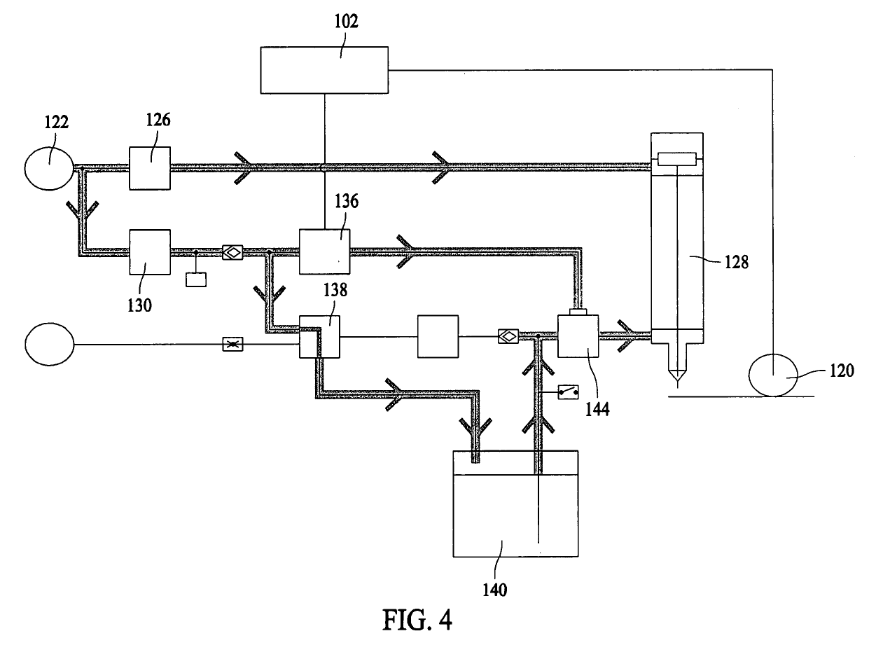

FIG. 4 is a schematic illustration of solvent applicator system 100 in a run mode of operation. During the run mode of operation of solvent applicator system 100, mode selector valve 138 is in the “RUN” mode. In the exemplary embodiment, pressure supply source 122 supplies pressure to dispensing valve 126 and pressure regulator 130. The pressure supplied to dispensing valve 126 is channeled to dispensing nozzle 128 to operate dispensing nozzle 128 in the “ON” mode of operation. The pressure supplied to pressure regulator 130 is channeled to controller valve 136 and mode selector valve 138. The pressure supplied to controller valve 136 is variably supplied to proportional valve 144 based on the signal received from controller 102 relating to the speed of web 10. The pressure supplied to mode selector valve 138 is channeled through valve 138 to supply line 124 extending between mode selector valve 138 and solvent tank 140. As such, pressurized fluid is channeled from supply source 122 to solvent tank 140 for pressurizing solvent in solvent tank 140. As illustrated in FIG. 4, no pressurized fluid is supplied to either purge sub-system 108 or exhaust sub-system 110 when solvent applicator system 100 is in the “RUN” mode of operation.

Due to the pressure increase in solvent tank 140, solvent 14 is channeled through solvent line 142 to proportional valve 144 prior to being channeled to dispensing nozzle 128. The amount of solvent 14 supplied to dispensing nozzle 128 is directly proportional to the amount of pressurized fluid supplied to proportional valve 144 from controller valve 136. As such, the amount of solvent 14 supplied to dispensing nozzle 128 is directly proportional to the speed of web 10. Additionally, due to the limited amount of solvent 14 channeled between proportional valve 144 and dispensing nozzle 128, the overall responsiveness of solvent applicator system 100 is increased over known applicator systems that must stabilize all of the solvent in the solvent tank and solvent lines between solvent tank and dispensing nozzle, which may be approximately one gallon, or more, of solvent 14.

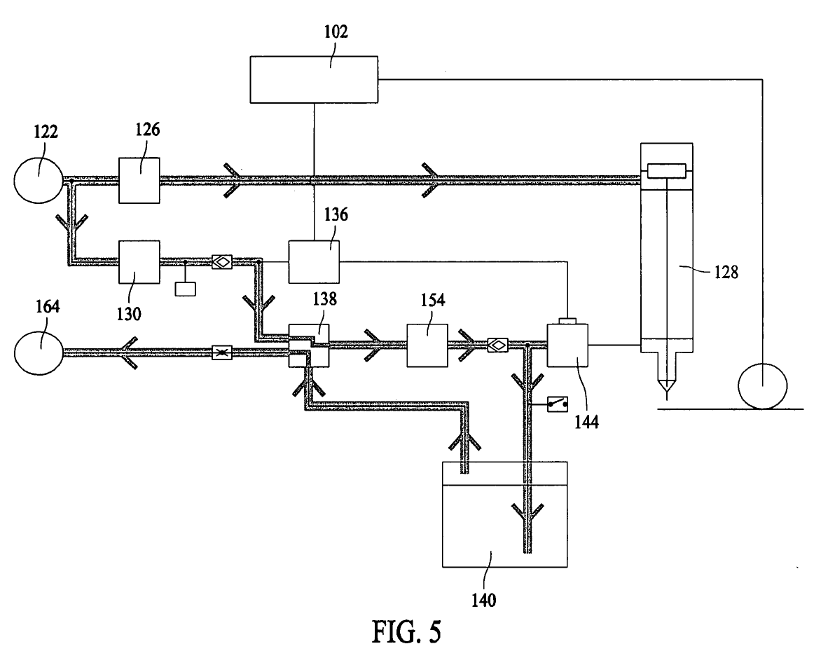

FIG. 5 is a schematic illustration of solvent applicator system 100 in a purge mode of operation. During the purge mode of operation of solvent applicator system 100, mode selector valve 138 is in the “PURGE” mode. In the exemplary embodiment, the purge mode of operation is used to purge solvent supply sub-system 106. As such, solvent 14 is not applied to web 10 during the purge mode of operation. In the exemplary embodiment, controller 102 transmits a signal to controller valve 136 that web 10 speed is zero. As a result, no pressure is supplied between controller valve 136 and proportional valve 144, and no solvent 14 is dispensed from proportional valve 144 and dispensing nozzle 128.

In the exemplary embodiment, pressure supply source 122 supplies pressure to pressure regulator 130. The pressure supplied to pressure regulator 130 is channeled to mode selector valve 138. The pressure supplied to mode selector valve 138 is channeled through valve 138 to purge line 156 extending between mode selector valve 138 and purge regulator 154. The pressurized fluid is then channeled downstream of purge regulator 154 and used to purge solvent 14 in solvent line 142 from proportional valve 144 to solvent tank 140. As illustrated in FIG. 5, the pressurized fluid used to purge solvent supply sub-system 106 is channeled from solvent tank 140 through supply line 124 to mode selector valve 138. The pressurized fluid is channeled through valve 138 directly to exhaust line 160 where it is exhausted through exhaust outlet 162. Due to the high concentration of harmful fumes in the exhausted fluid, exhaust outlet 162 is generally positioned adjacent ventilation system 164.

The above-described solvent applicator system for applying solvent to a web of material operates in a cost-effective and reliable manner. The solvent applicator system includes a solvent supply sub-system operatively coupled to a pressure supply sub-system. Specifically, the pressure supply sub-system supplies pressurized fluid to a proportional valve that also receives a supply of solvent from the solvent supply sub-system. The proportional valve is closely coupled to a dispensing nozzle for dispensing the solvent to the web. In the exemplary embodiment, the proportional valve receives a supply of pressurized fluid from a controller valve that is directly proportional to the speed of the web. As a result, the solvent applicator system facilitates controlling the flow of solvent to the dispensing valve according to the speed of the web in a reliable and cost-effective manner by increasing the overall system responsiveness and reducing the lag in the system. Specifically, the lag is reduced due to the small volume of solvent that must be stabilized by the system in response to a change in speed of the web.

Exemplary embodiments of solvent applicator systems are described above in detail. The systems are not limited to the specific embodiments described herein, but rather, components of each system may be utilized independently and separately from other components described herein. For example, each solvent applicator system component can also be used in combination with other solvent applicator system components.

While the invention has been described in terms of various specific embodiments, those skilled in the art will recognize that the invention can be practiced with modification within the spirit and scope of the claims.

What is claimed is:

1. A solvent applicator for applying a solvent to a web, wherein the solvent is supplied through a first solvent line from a solvent tank via a pressure increase in the solvent tank from a pressure source, said solvent applicator comprising:
a controller;
a first valve in flow communication with the pressure source, said first valve configured to control an amount of pressure output based on a signal received from said controller;
a second valve in flow communication with said first valve and in flow communication with the first solvent line, said second valve configured to control an amount of solvent output based on the amount of the pressure output from said first valve; and
a dispensing nozzle coupled in flow communication with said second valve, said dispensing nozzle configured to receive the solvent output from said second valve, said dispensing nozzle positioned a distance above the web.

2. A solvent applicator in accordance with claim 1 wherein said dispensing nozzle is positioned the distance from the web to facilitate applying the solvent as a spray.

3. A solvent applicator in accordance with claim 1 wherein the signal is proportional to a speed of the web.

4. A solvent applicator in accordance with claim 1 wherein said dispensing nozzle and said second valve are coupled in flow communication via a second solvent line.

5. A solvent applicator in accordance with claim 1 wherein said dispensing nozzle is directly coupled to said second valve.

6. A solvent applicator in accordance with claim 1 wherein said first valve is an electro-pneumatic valve configured to change an electrical signal from said controller to a corresponding pressure output of pressurized fluid to said second valve.

7. A solvent applicator in accordance with claim 6 further comprising a line speed encoder for determining the speed of the web, said controller configured to receive a signal from said line speed encoder and transmit a corresponding signal to said electro-pneumatic valve that is directly proportional to the speed of the web.

8. A solvent applicator in accordance with claim 1 wherein said second valve is a proportional valve configured to channel a predetermined amount of solvent to said dispensing nozzle based on the pressure output of said first valve.

9. A solvent applicator system for applying a solvent to a web, said system comprising:
a controller;
a pressure supply sub-system comprising a pressure supply, at least one supply line, a control valve in flow communication with said pressure supply by a first of said supply lines, and a mode selector valve in flow communication with said pressure source by a second of said supply lines, said control valve configured to control an amount of pressure output from said control valve based on a signal received from said controller; and
a solvent supply sub-system comprising a solvent tank, at least one solvent line, a proportional valve in flow communication with said solvent tank via a first of said solvent lines, and a dispensing nozzle in flow communication with said proportional valve, said dispensing valve in flow communication with said control valve, said proportional valve configured to control an amount of solvent output to said dispensing nozzle based on the amount of the pressure output from said control valve, said dispensing nozzle configured to apply the solvent to the web.

10. A solvent applicator system in accordance with claim 9 wherein said dispensing nozzle is positioned a distance from the web to facilitate applying the solvent as a spray.

11. A solvent applicator system in accordance with claim 9 wherein the signal is proportional to a speed of the web.

12. A solvent applicator system in accordance with claim 9 wherein said dispensing nozzle and said proportional valve are coupled in flow communication via a second of said solvent lines, wherein said second solvent line has a length selected to facilitate an immediate response in solvent application to the web based on a change in the speed of the web.

13. A solvent applicator system in accordance with claim 9 wherein said dispensing nozzle is directly coupled to said proportional valve.

14. A solvent applicator system in accordance with claim 9 wherein said control valve is an electro-pneumatic valve configured to change an electrical signal from said controller to a corresponding pressure output of pressurized fluid to said proportional valve.

15. A solvent applicator system in accordance with claim 14 further comprising a line speed encoder for determining the speed of the web in relation to said dispensing nozzle, the signal received by said electro-pneumatic valve from said controller is directly proportional to a signal received by said controller from said line speed encoder.

16. A solvent applicator system in accordance with claim 9 wherein said proportional valve is configured to channel a predetermined amount of solvent to said dispensing nozzle based on the pressure output of said control valve.

17. A solvent applicator system in accordance with claim 9 further comprising a purge sub-system comprising a purge regulator coupled in flow communication with said mode selector valve and in flow communication with said first solvent line, said mode selector valve selectively operable between a run mode of operation and a purge mode of operation, such that when said mode selector valve is operated in the purge mode, said purge regulator is configured to receive pressurized fluid from the pressure supply and is configured to purge the solvent in said first solvent line from said proportional valve to said solvent tank.

18. A solvent applicator system in accordance with claim 17 further comprising an exhaust sub-system comprising an exhaust line in flow communication with said mode selector valve, such that when said mode selector valve is operated in the purge mode, said exhaust line is configured to exhaust the pressurized fluid from said solvent tank.

19. A solvent applicator system for applying a solvent to a web, wherein the solvent is supplied through a first solvent line from a solvent tank via a pressure increase in the solvent tank from a pressure source, said system comprising:
a sensor configured to detect a line speed of the web;
a controller configured to receive the signal from said sensor;
a first valve in flow communication with the pressure source, said first valve configured to control an amount of pressure output based on a signal received from said controller relating to the line speed of the web;
a second valve in flow communication with said first valve and in flow communication with the first solvent line, said second valve configured to control an amount of solvent output based on the amount of the pressure output from said first valve relating to the line speed of the web; and
a dispensing nozzle coupled in flow communication with said second valve, said dispensing nozzle configured to receive the solvent output from said second valve relating to the line speed of the web.

20. A solvent applicator system in accordance with claim 19 wherein said dispensing nozzle is positioned the distance from the web to facilitate applying the solvent as a spray.

21. A solvent applicator system in accordance with claim 19 wherein said first valve is an electro-pneumatic valve configured to change an electrical signal from said controller to a corresponding pressure output of pressurized fluid to said second valve.

22. A solvent applicator system in accordance with claim 21 wherein said sensor comprises a line speed encoder for determining the speed of the web in relation to said dispensing nozzle, the signal received by said electro-pneumatic valve from said controller is directly proportional to a signal received by said controller from said line speed encoder.

23. A solvent applicator system in accordance with claim 19 wherein said second valve is a proportional valve configured to channel a predetermined amount of solvent to said dispensing nozzle based on the pressure output of said first valve.

24. A method of operating a solvent applicator system, wherein the solvent applicator system includes a controller, a pressure supply for supplying a pressurized fluid, at least one supply line for channeling the pressurized fluid, a plurality of valves, a solvent tank, at least one solvent line for channeling the solvent, and a dispensing nozzle for applying the solvent to a web of material, said method comprising:
supplying pressure to the tank through a first valve;
supplying pressure to a dispensing nozzle through a second valve and a third valve; and
supplying solvent from the tank to the nozzle through the third valve, wherein the pressure supplied to the third valve is proportional to the speed of the web.

25. A method in accordance with claim 24 wherein said supplying pressure to the tank through a first valve comprises:
supplying pressure from the pressure supply through a supply line to the first valve; and
supplying pressure from the valve through a supply line to the tank.

26. A method in accordance with claim 24 wherein said supplying pressure to a dispensing nozzle through a second valve and a third valve comprises supplying pressure through a supply line to the second valve, and supplying pressure from the second valve through a supply line to the third valve, said supplying solvent from the tank to the nozzle through the third valve comprises supplying solvent from the tank through a solvent supply line to the third valve, and supplying solvent from the third valve to the nozzle through a solvent supply line.

27. A method in accordance with claim 24 wherein said supplying pressure to a dispensing nozzle through a second valve and a third valve comprises supplying pressure through a supply line to the second valve, and supplying pressure from the second valve through a supply line to the third valve, and said supplying solvent from the tank to the nozzle through the third valve comprises supplying solvent from the tank through a solvent supply line to the third valve, and supplying solvent from the third valve to the nozzle through a direct coupling.

28. A method in accordance with claim 24 wherein the system further includes a sensor, said method further comprising:
determining the speed of the web using the sensor;
transmitting a signal relating to the speed of the web from the sensor to the controller;
transmitting a signal relating to the speed of the web from the controller to the second valve; and
controlling the amount of pressure supplied from the second valve to the third valve based on the signal received from the controller.

29. A method in accordance with claim 28 wherein said controlling the amount of pressure supplied comprises varying the pressure output of the first valve based on the speed of the web.

30. A method in accordance with claim 24 wherein said supplying solvent from the tank to the nozzle through the third valve comprises supplying a predetermined amount of solvent from the third valve to the nozzle, wherein the predetermined amount of solvent supplied to the nozzle is related to the amount of pressure supplied to the third valve from the second valve.

31. A method in accordance with claim 24 wherein said supplying solvent from the tank to the nozzle through the third valve comprises varying the amount of solvent supplied to the nozzle in response to the speed of the web.
